(19) United States
(12) Patent Application Publication
(10) Pub. No.: US 2019/0088025 A1
(43) Pub. Date: Mar. 21, 2019

(54) SYSTEM AND METHOD FOR AUTHORING AND VIEWING AUGMENTED REALITY CONTENT WITH A DRONE

(71) Applicant: DroneBase, Inc., Santa Monica, CA (US)

(72) Inventors: Eli Yakushiji Tamanaha, Santa Monica, CA (US); Michael David Murphy, Venice, CA (US); Michael James Onorato, Austin, TX (US); Jared Peter Tafralian, Altadena, CA (US)

(21) Appl. No.: 16/132,144

(22) Filed: Sep. 14, 2018

Related U.S. Application Data
(60) Provisional application No. 62/559,222, filed on Sep. 15, 2017.

(51) Int. Cl. G06T 19/00; G06F 3/0481; G06F 3/0484; B64C 39/02; G05D 1/00

(52) U.S. Cl. CPC G06T 19/006; G06F 3/04815; G06F 3/0484; B64C 2201/127; G05D 1/005; B64C 2201/146; B64C 39/024

(57) ABSTRACT

A display device receives video data, location data, position data from a remotely controlled unmanned aerial vehicle (UAV). The display device converts a first set of coordinates from the location and position data to a second set of coordinates of a virtual world model. A user of the display device provides a selection of an AR object at the display device that is also used to control the remotely controlled UAV. The display device associates the selected AR object with the second set of coordinates and providing information of the selected AR object and the second set of coordinates to a server.

### CROSS REFERENCE TO RELATED APPLICATIONS

The present application claims the benefit of U.S. Provisional Application No. 62/559,222 filed on Sep. 15, 2017, the entire disclosure of which is incorporated herein in its entirety by reference.

### TECHNICAL FIELD

The subject matter disclosed herein generally relates to augmented reality content. Specifically, the present disclosure addresses systems and methods for authoring and viewing augmented reality content using a remote controlled device such as a drone.

### BACKGROUND

Augmented Reality typically refers to machine-based augmentation of a person's sensory perception of a physical, real-world environment. Within the context of visual augmented reality, a person's view of the real-world environment is supplemented or otherwise altered by computer-generated graphical content to create the appearance that the graphical content is present within the real-world environment. Some display devices (e.g., smartphone, tablets) for AR may capture a live view of the real-world environment via an on-board camera, and present that live view via a graphical display along with computer-generated graphical content integrated with the live view. Other display devices (e.g., head-mounted devices) used for AR can also incorporate one or more see-through display panels upon which graphical content is displayed to the user, enabling the user to directly view both the real-world environment and the graphical content within a combined AR view.

AR content (e.g., three-dimensional model of a physical object) is typically created on a client device such as a desktop or laptop computer. The user forms the AR content using an AR content authoring tool on the client device. The AR content is associated with an identification of a physical object and then stored on a server. The AR content is provided to the AR display device when the AR display device recognizes a corresponding physical object.

### SUMMARY

Methods and apparatuses for authoring and viewing augmented reality content using a remote controlled device are disclosed herein. According to one method, video data, location data, position data is received from a remotely controlled unmanned aerial vehicle (UAV); a first set of coordinates from the location and position data is converted to a second set of coordinates of a virtual world model; a selection of an AR object is received at an AR display device used to control the remotely controlled UAV; the selected AR object is associated with the second set of coordinates; and information of the selected AR object and the second set of coordinates are provided to a server.

In another embodiment, the method includes: receiving video data, location data, position data from a remotely controlled unmanned aerial vehicle (UAV); converting a first set of coordinates from the location and position data to a second set of coordinates of a virtual world model; retrieving information of an AR object associated with the second set of coordinates; and displaying the AR object in a video feed from the UAV.

In yet another embodiment, a non-transitory computer-readable medium comprising instructions that, when executed by one or more processors of a machine, cause the machine to perform the following operations: receiving video data, location data, position data from a remotely controlled unmanned aerial vehicle (UAV); converting a first set of coordinates from the location and position data to a second set of coordinates of a virtual world model; receiving a selection of an AR object at an AR display device used to control the remotely controlled UAV; associating the selected AR object with the second set of coordinates; and providing information of the selected AR object and the second set of coordinates to a server.

In yet another embodiment, a non-transitory computer-readable medium comprising instructions that, when executed by one or more processors of a machine, cause the machine to perform the following operations: receiving video data, location data, position data from a remotely controlled unmanned aerial vehicle (UAV); converting a first set of coordinates from the location and position data to a second set of coordinates of a virtual world model; retrieving information of an AR object associated with the second set of coordinates; and displaying the AR object in a video feed from the UAV.

Other features and advantages will become apparent from the following detailed description, taken in conjunction with the accompanying drawings, which illustrate by way of example, the features of the various embodiments.

### BRIEF DESCRIPTION OF THE DRAWINGS

Some embodiments are illustrated by way of example and not limitation in the figures of the accompanying drawings.

FIG. 1 is a network diagram illustrating a network environment suitable for authoring and viewing augmented reality (AR) content, according to some example embodiments.

FIG. 2 is a block diagram illustrating an example embodiment of an AR display device.

FIG. 3 is a block diagram illustrating an example embodiment of an AR authoring application.

FIG. 4 is a block diagram illustrating an example embodiment of an AR viewing application.

FIG. 5 is a block diagram illustrating components of a server machine suitable for receiving and providing augmented reality content, according to some example embodiments.

FIG. 6 is a flowchart illustrating a method for authoring AR content using a drone, according to an example embodiment.

FIG. 7 is a flowchart illustrating a method for viewing AR content using a drone, according to an example embodiment.

FIG. 8 is a block diagram illustrating an example of a drone located in a physical space associated with a virtual object.

FIG. 9 is a block diagram illustrating an example architecture of a system for authoring and viewing AR content using a drone, according to some example embodiments.

FIG. 10 is a block diagram illustrating components of a machine, according to some example embodiments, able to read instructions from a machine-readable medium and perform any one or more of the methodologies discussed herein.

FIG. 11 is a diagram illustrating a method for synchronizing video frames with a position/pose data, according to some example embodiments.

### DETAILED DESCRIPTION

Example methods and systems are directed to a system and method for authoring and viewing augmented reality (AR) content using a drone. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Small Unmanned Aerial Vehicles (UAVs), also referred to as “drones” are typically equipped with one more cameras that enables a user (also referred to as a pilot) of the drone to take pictures and record video. The user can operate the drone to perform a variety of flight patterns using a remote control that wirelessly communicates with the drone. The user can also view live video or pictures taken from the camera on the drone by connecting a mobile computing device (e.g., display device, smartphone, laptop) to the remote control.

In one example embodiment, the mobile computing device (also referred to as display device) can also be used to display Augmented Reality (AR) content (e.g., virtual objects that appear to be part of the real-world environment). For example, the virtual objects appear as three-dimensional model of a physical object that appear to be coupled relative to a fixed location (e.g., a block appearing to float in a fixed location above a physical landmark such as a theater or museum). The location and position of the virtual object may be defined or identified relative to a fixed location in space (e.g., spatial coordinates), relative to the physical landmarks, or relative to other virtual objects.

The mobile computing device renders and displays the three-dimensional model of the virtual object as an overlay to a video or image received from the drone to create the appearance that the virtual object is present within the real-world environment. The camera of the drone captures a live view of the real-world environment, and transmits the video data from the camera and position data from sensors (e.g., compass, altimeter, Inertial Measurement Unit sensor, Global Positioning System sensor) in the drone to the remote control and/or the mobile computing device. The mobile computing device displays a live view via a graphical display along with computer-generated graphical content integrated with the live view.

In another example, the mobile computing device enables drone pilots to view augmented reality content from their drones. As the pilot flies his/her drone, he/she can see 3D graphics rendered on the screen of his/her mobile computing device and overlaid on top of the streaming video from the camera of the drone. Those 3D graphics are scaled and rotated according to the drone's movements, so that they appear to exist in the real world.

In addition to viewing the existing or predefined AR content, the pilot is also able to create new graphics where his/her drone is located. In this way, he/she uses his drone as a cursor for the real world, analogous to a mouse cursor for the monitor. For example, the pilot may “draw” or “paint” using the sky as a canvas. The pilot can create virtual colored lines or brush strokes by flying the drone in user-controlled flight patterns. The “painting” would appear to be part of the sky when viewed through the display of another drone located in proximity (e.g., within a mile radius) to the location/placement of the “painting.”

In another example, the pilot may “place” or “drop” virtual objects in the sky such as a building blocks to build more complex virtual objects in the sky wherein the virtual objects would appear to be part of the real-world environment as perceived from a camera of a drone flying in proximity to the virtual objects.

Other examples include, but are not limited to:

A pilot wishes to create a virtual piece of art (e.g., abstract designs, text signs, murals, sculptures) in the sky. In the case of sculptures, the pilot first places a large cluster of virtual blocks in the air. The pilot then deletes selected pieces of the large cluster of virtual blocks to sculpt the large cluster into an artwork.

A pilot wishes to create a virtual building on an open plot of land. He/she places virtual blocks to construct all the surfaces, including walls, beams, rafters, etc.

A pilot wishes to collaboratively create a virtual object in the sky. As the pilot places virtual blocks, these virtual blocks are immediately visible to other pilots. All pilots can create and delete virtual blocks collaboratively and see each other's work in real-time. Thus, when one pilot places a virtual block, other pilots are able to see the placed virtual block. All or different pilots can have different types of access (e.g., edit access, view only access).

A pilot wishes to create his own game. For example, the pilot places “target blocks” in the air. Then, he or another pilot can “shoot” or delete those target blocks by placing the target block in the viewfinder's crosshairs displayed in the AR display device 101 and then pressing a delete button.

For mission-based drone flights, virtual instructions can be placed in specific locations in the air. The specific locations identify where the pilot is supposed to take certain photographic shots. For example, an instruction includes taking a specific picture from the NW corner of a building, at 100 feet in altitude, with the drone camera pointed at a 75 degree vertical angle. In that example, a virtual arrow is placed exactly where the shot is to be taken and at the specified angle.

3D CAD drawings can also be converted and displayed as AR content in the AR display device 101. For example, a construction company may wish to see what a building is going to look like before it is built. The CAD file for the building is converted into a 3D model, and placed in the AR content exactly where the building is supposed to be built. The scale of the virtual building will match the true scale of the future building. From there, a drone pilot can fly around or through the virtual building and take pictures/video of the virtual building within the real-world background.

Previous versions of AR for drones have struggled because of a lack of synchronization between the AR graphics and the underlying video. For example, when the drone pans its camera from left to right, the video shows this movement immediately. However, the AR graphics lag behind, and only later do they catch up to their correct positions in the video scene. This breaks the illusion that the AR graphics exist in the real world. The present disclosure describes a system and method to synchronize the position of the graphics with the underlying video much better so that the AR content appears to be immersed and part of the real world especially when the camera of the drone pan or moves around.

In another example embodiment, a non-transitory machine-readable storage device may store a set of instructions that, when executed by at least one processor, causes the at least one processor to perform the method operations discussed within the present disclosure.

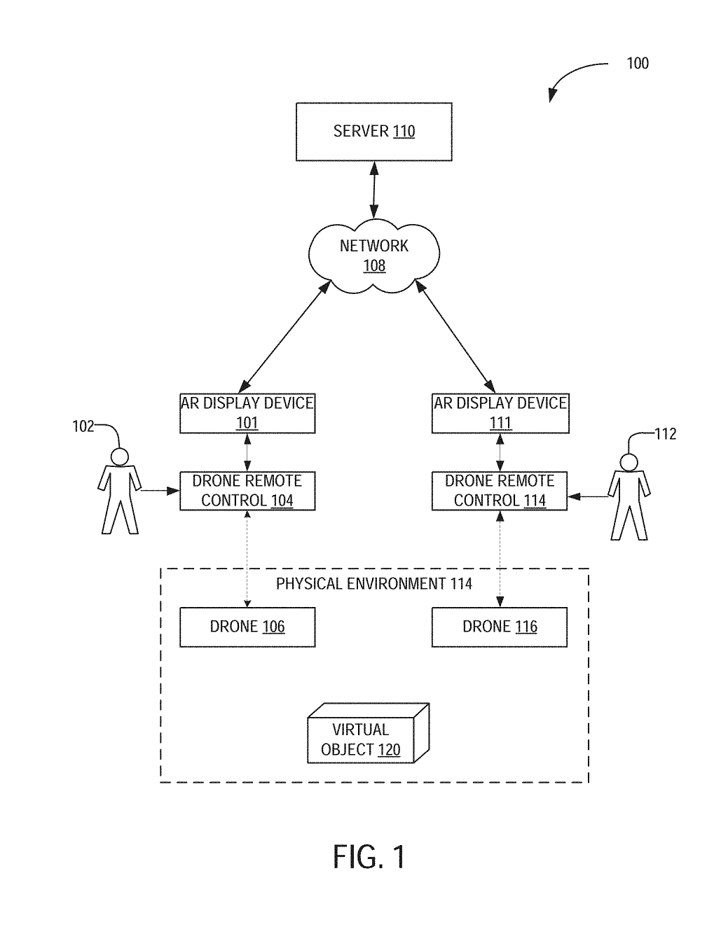

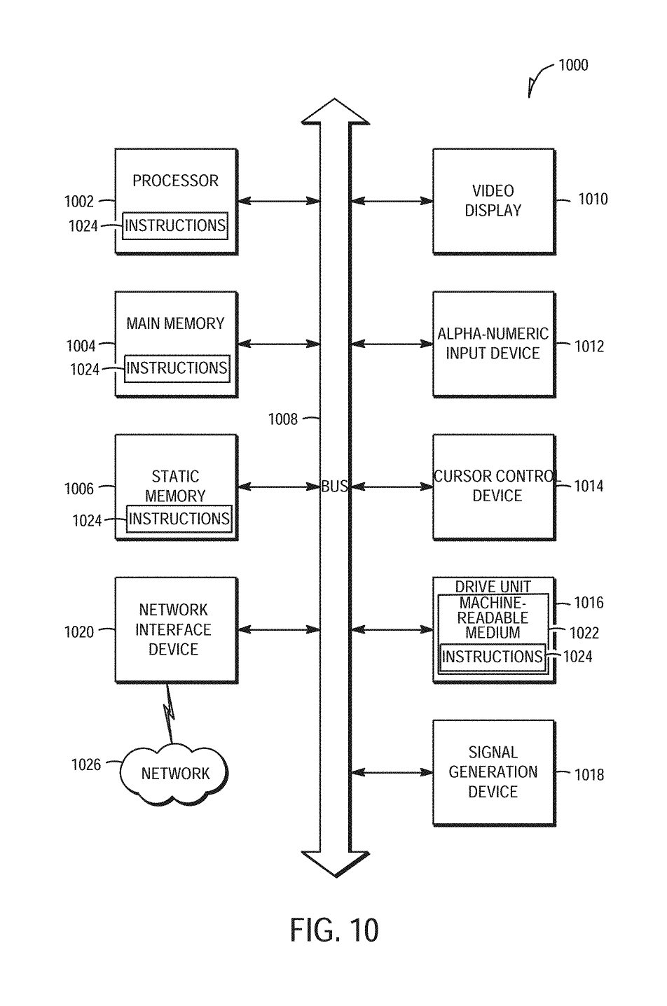

FIG. 1 is a network diagram illustrating a network environment suitable for authoring and viewing augmented reality (AR) content, according to some example embodiments. The AR display devices 101, 111 and the server 110 may each be implemented in a computer system, in whole or in part, as described below with respect to FIG. 10. The server 110 may be part of a network-based system. For example, the network-based system may be or include a cloud-based server system that provides AR content (e.g., augmented information including 3D models of virtual objects corresponding to position/location coordinates) to the AR display devices 101, 111.

The AR display device 101 includes a graphical display for a user 102 to view the AR content (e.g., virtual object 120) that appear to be part of a real-world physical environment 114. The user 102 controls the drone 106 through a drone remote control 104 in wireless communication with the drone 106. The user 102 may be a human user (e.g., a human being), a machine user (e.g., a computer configured by a software program to interact with the AR display device 101), or any suitable combination thereof (e.g., a human assisted by a machine or a machine supervised by a human). The user 102 is not part of the network environment 100, but is associated with the AR display device 101.

In one example embodiment, the AR display device 101 is connected to the drone remote control 104 and receives data indicating a position, location, video, audio, images broadcast from the drone 106 to the drone remote control 104. The AR display device 101 determines the AR content to be rendered and displays the AR content in the display of the AR display device 101 based on video data, image data, audio data, position/location data, and other sensor data from the drone 106.

In another example embodiment, the AR display device 101 displays AR content that are based on identified physical objects in the physical environment 114. For example, the physical environment 114 may include identifiable physical objects such as a 2D physical object (e.g., a picture), a 3D physical object (e.g., a building, a flagpole at the top of a building, a physical landmark), or any other references (e.g., a specific location on the ground) in the real-world physical environment 114. In another example embodiment, the AR display device 101 uses computer vision to identify physical objects depicted in the video/images generated by the drone 106. Furthermore, the user 102 can control the drone 106 using the drone remote control 104 to point the camera of the drone to in a particular orientation or pose in the physical environment 114.

In one example embodiment, the AR display device 101 determines a geographic location (e.g., GPS location coordinates) and orientation of the drone 106 within the physical environment 114. The AR display device 101 determines that the geographic location of the drone 106 is within a predefined radius of the location of the virtual object 120. For example, the user 102 uses the drone 106 to “place” the virtual object 120 at a user-selected location). In response, the AR display device 101 retrieves the three-dimensional model of the virtual object 120 and renders the virtual object 120 based on the location/position/pose of the drone relative to the location/placement of the virtual object 120. The AR display device 101 displays the virtual object 120 when the virtual object 120 is within a field of view of the camera of the drone 106.

The virtual object 120 appears bigger in the display of the AR display device 101 as the drone 106 moves closer to the virtual object 120. Conversely, the virtual object 120 appears smaller as the drone 106 moves farther away from the virtual object 120.

In another example embodiment, the drone 106 may be used to place the virtual object 120 within the physical environment 114. For example, the user 102 uses the AR display device 101 to select a virtual object (e.g., a building block, a cloud) and place the selected virtual object at or based on a location of the drone 106. In one example, the virtual object is placed a few feet “in front” of the drone 106 so that the user 102 can visualize and see the virtual object being placed within the image captured by the drone 106. The AR display device 101 uploads the placement information and other data (e.g., radius within which a drone is located from the placement location of the virtual object 120 in order to display the virtual object 120) related to the virtual object 120 to the server 110. The AR display device 111 retrieves data for the virtual object 120 from the server 110 and displays the virtual object 120 when the drone 116 is in proximity to the virtual object 120.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The network 108 may be any network that enables communication between or among machines (e.g., the server 110), databases, and devices (e.g., the AR display device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

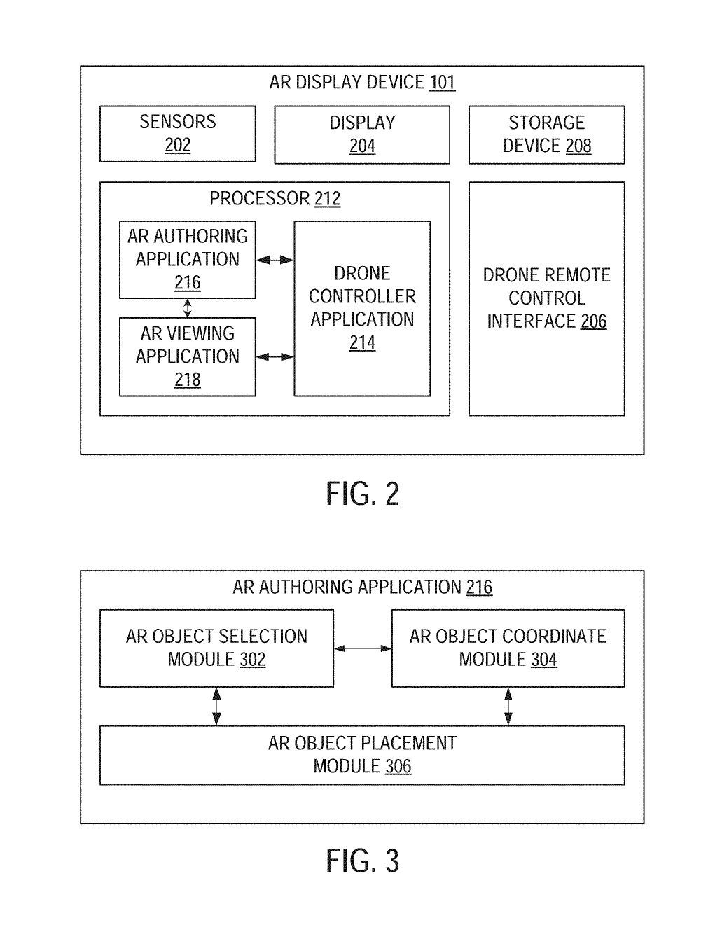

FIG. 2 is a block diagram illustrating an example embodiment of the AR display device 101. The AR display device 101 includes sensors 202, a display 204, a storage device 208, a drone remote control interface 206, and a processor 212.

The sensors 202 may include, for example, a camera (e.g., different spectrum), an audio sensor, an Inertial Measurement Unit (IMU) sensor, a location sensor (e.g., GPS sensor, Wi-Fi, Bluetooth), a barometer, a humidity sensor. It is to be noted that the sensors 202 described herein are for illustration purposes. The sensors 202 are thus not limited to the ones described.

The display 204 may include a display surface (transparent or non-transparent) or lens capable of displaying AR content (e.g., computer-generated graphics) generated by the processor 212.

The storage device 208 stores a library of AR content, a speech recognition application, a language dictionary, a contextual content dataset, and reference objects. The AR content may include two- or three-dimensional models of virtual objects with corresponding audio. In other examples, the AR content may include an AR application that includes interactive features such as displaying additional data (e.g., locations of sprinklers) in response to user input (e.g., a user says, “Show me the locations of the sprinklers” while looking at an AR overlay showing locations of the exit doors). AR applications may have their own different functionalities and operations. Therefore, each AR application may operate distinctly from other AR applications.

The storage device 208 may also store a database of geographic coordinates and corresponding virtual object models. In another embodiment, the database may also identify reference objects (e.g., a flag on a building), and corresponding virtual objects (e.g., 3D model of physical object), interactive features of the 3D virtual objects (e.g., flashing colors, triggered features).

In another example embodiment, the database includes a predefined set of virtual objects (e.g., blocks of different colors, shapes, or other different types of virtual objects such as a cloud, arrow, banner) that can be placed in the physical environment 114. The database includes a core set of predefined virtual objects and a supplemental set of virtual objects that may be based on the location of the AR display device.

The drone remote control interface 206 receives location, position, orientation data from the drone 106. In one example, the drone remote control 104 receives video data, location data, motion data from the drone 106 and communicates the data to the AR display device 101.

The position and the orientation of the drone 106 is used to identify real-world objects in a field of view of the camera in the drone 106. For example, a virtual object may be rendered and displayed in the display 204 when the sensors in the drone 106 indicate that the drone 106 is oriented towards a real-world object (e.g., when the drone 106 captures an image of a flag pole on top of a building that is within a field of view of the image sensors of the drone 106).

The AR display device 101 may also display a virtual object based on a geographic location of the drone 106. For example, a set of virtual objects may be accessible when the user 102 pilots the drone 106 to a particular geographic region or space. In one example, the AR display device 101 displays clouds when the drone 106 flies over a particular geographic location.

In one example embodiment, the AR display device 101 communicates over the network 108 with the server 110 to access a preset inventory of virtual objects (to be used for placement) and a library of virtual objects (e.g., already placed) and their corresponding coordinates from the server 110. In another example embodiment, the AR display device 101 retrieves a portion of a database of geographic locations, corresponding virtual objects, and corresponding interactive features of the 3D virtual objects.

The processor 212 include a drone controller application 214, an AR authoring application 216, and an AR viewing application 218. The drone controller application 214 enables the user to control the flight path of the drone 106, view a live video feed from a camera of the drone 106, view other data (e.g., position coordinates, altitude, direction, orientation, etc.) from sensors in the drone 106.

The AR authoring application 216 enables the user 102 to select and place virtual objects at user-specified location in the physical environment 114 of the real world. The AR viewing application 218 retrieves and renders virtual objects previously placed by the user 102 or other users, such as user 112, when the drone 106 is located within a predefined radius of the user-specified location.

FIG. 3 is a block diagram illustrating an example embodiment of the AR authoring application 216. The AR authoring application 216 includes an AR object selection module 302, an AR object coordinate module 304, and an AR object placement module 306. The AR object selection module 302 retrieves a preset selection of virtual objects and presents them to the user 102 for selection. For example, the user 102 may select a virtual object by tapping on an image of the virtual object on the display of the AR display device 101. In another example embodiment, the AR object selection module 302 provides a virtual block with different functionalities or interactive features. For example, the virtual object can provide a specific functionality when the drone “touches” or flies through the virtual object. A start/stop virtual block may be placed at a specific location in the sky so that a timer is triggered (e.g., timer starts or stops) every time a drone (e.g., a specific drone, any drone) “touches” the virtual block. In other examples, a drone “touches” a first virtual block to trigger an operation or a function in a second virtual block (e.g., a first virtual block changes color every time a drone flies through a second virtual block).

The AR object coordinate module 304 retrieves a first set coordinates of the drone 106 from the drone remote control interface 206 and converts the first set of coordinates to a second set of coordinates. In one example embodiment, the drone 106 provides its coordinates to the drone remote control 104 in terms of GPS coordinates (e.g., latitude, longitude, and altitude). The AR object coordinate module 304 converts the latitude, longitude, and altitude coordinates to a Cartesian coordinate space (e.g., “Earth-Centered, Earth-Fixed” (ECEF) coordinate space). However, because the origin of the Cartesian coordinate space is the center of the Earth, the coordinates of the virtual object 120 on the surface of the Earth contain very large values (when measured in meters). A pilot may place virtual objects that are within a few meters from one another. Therefore, the value difference in coordinates of adjacent virtual objects may be so small to be within a rounding error resulting in virtual objects that would appear to be sharing a same location.

The AR object coordinate module 304 converts the ECEF coordinate space to a “North East Down” (NED) coordinate space. In the NED coordinate space, the origin is the point where the drone 106 takes off from the ground. The XYZ axes extend to the north, east, and up. The NED coordinate space provides measurement values that enables the AR object coordinate module 304 to distinguish the location of virtual objects that are placed within a short distance (e.g., one meter) of one another.

The AR object placement module 306 associates the selected virtual object with the converted coordinates (e.g., NED coordinate space) of the drone 106. In one example embodiment, the AR object placement module 306 places a block exactly at the location of the drone 106. This applies to “original blocks”—blocks that are not connected (or adjacent) to other blocks. Each original block appears facing the drone 106, no matter what direction the drone 106 is facing in terms of pitch, roll, or yaw. Therefore, the “original” block has its own position and pose data.

In another example embodiment, blocks can be snapped to existing blocks. Snapped blocks are aligned to the original block. For example, when the user 102 places a new block and there are no other blocks in the immediate vicinity (e.g., within one meter or any other preset radius or distance), that new block becomes an “original” block. A database in the storage device 208 stores the location/position/pose data of the “original block.”

However, if there are other blocks in the immediate vicinity of the new block, the new block “snaps” to the existing block/cluster of blocks. In that case, the new block is added to the cluster. Clusters contain the original block's position and pose, plus integer values to represent the XYZ grid location of the other blocks in the cluster relative to the original block. All blocks within a cluster are aligned with each other (e.g., they fit perfectly; there are no overlapping or slivers of space in between). The unit of measurement within the cluster's coordinate space is one block. For example, a block inside of a cluster might be referenced by (3,2,5), which means 3 blocks in the X direction, 2 blocks in the Y direction, and 5 blocks in the Z direction. An individual block may have preset measurements.

In another example embodiment, clusters of blocks can be oriented in different of angles relative to each other. However, within a single cluster, all the blocks are aligned perfectly with each other.

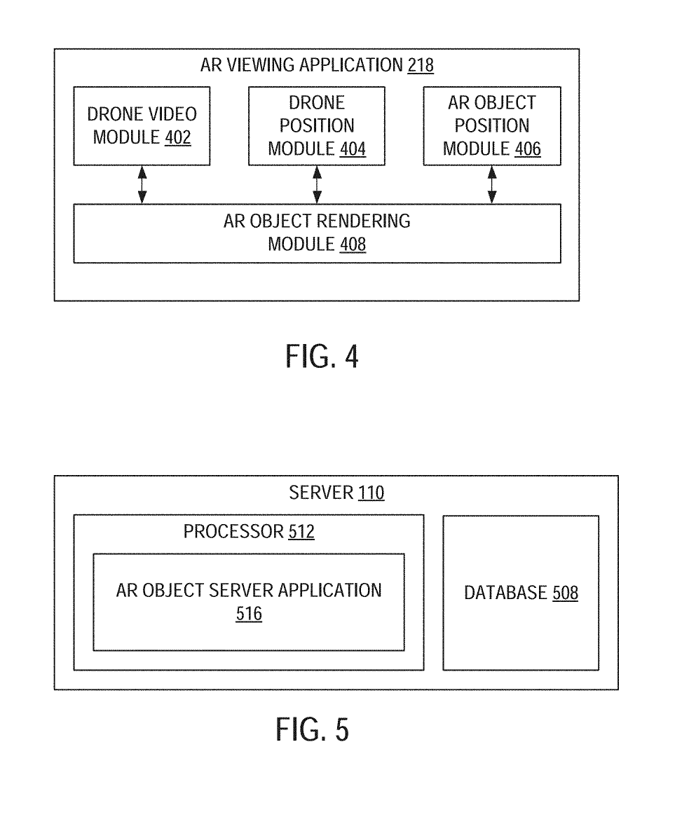

FIG. 4 is a block diagram illustrating an example embodiment of the AR viewing application 218. The AR viewing application 218 includes a drone video module 402, a drone position module 404, an AR object position module 406, and an AR object rendering module 408. The drone video module 402 retrieves a live video feed from a camera of the drone 106. The drone position module 404 retrieves a location (e.g., absolute or relative coordinates, converted coordinates) of the drone 106. The AR object position module 406 retrieves the location/orientation of the placed virtual object associated with the location/orientation of the drone 106. The AR object rendering module 406 retrieves and renders the virtual object associated with the location of the drone 106 in the display 204 as part of the live video feed from the drone 106.

FIG. 5 is a block diagram illustrating components of a server machine suitable for receiving and providing augmented reality content, according to some example embodiments. The server 110 includes a processor 512, and a database 508. The processor 512 includes an AR object server application 516 that provides virtual objects and corresponding coordinates to the drones. The database 508 stores the 3D model of the virtual objects and corresponding coordinates, position data, orientation data.

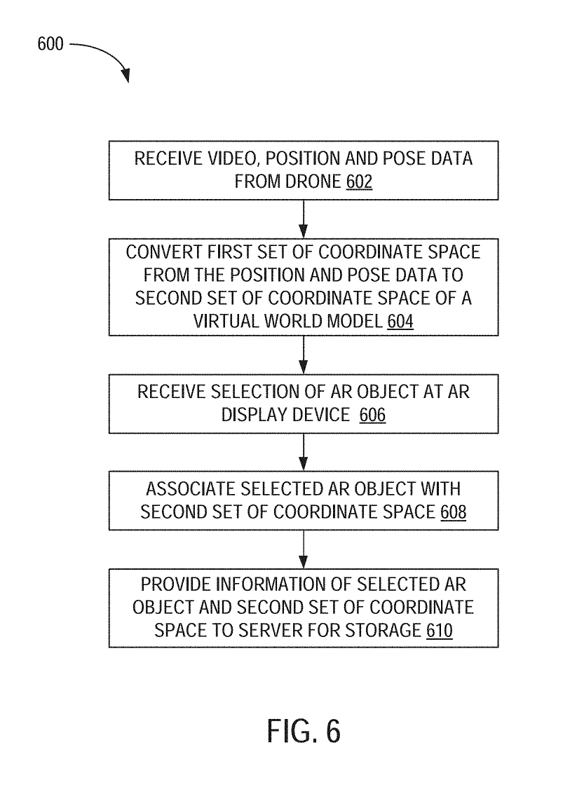

FIG. 6 is a flowchart illustrating a method for authoring AR content using a drone, according to an example embodiment. At step 602, the AR display device 101 and/or server 110 receives video, position, and pose data from a drone. At step 604, the first set of coordinate space from the position and pose data is converted into a second set of coordinate space of a virtual world model. At step 606, a selection of AR objects are received at the AR display device. At step 608, the selected AR object is associated with the second set of coordinate space. At step 610, the information of the selected AR object and second set of coordinate space is provided to the server for storage.

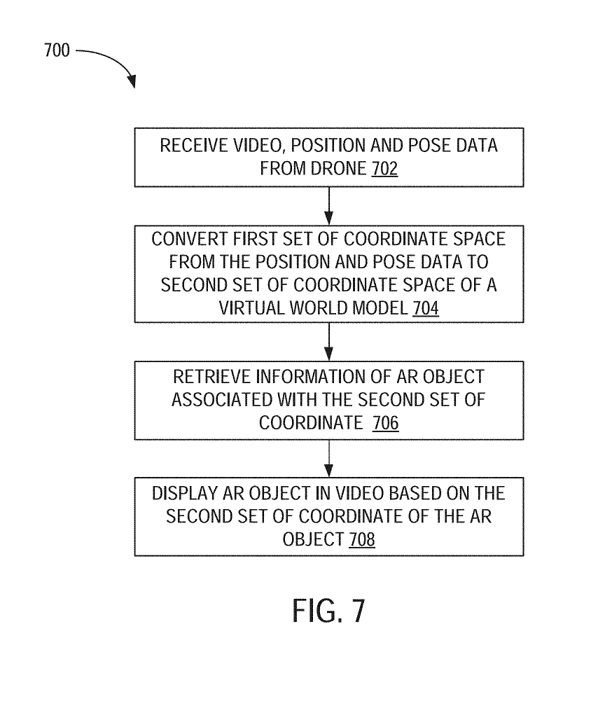

FIG. 7 is a flowchart illustrating a method for viewing AR content using a drone, according to an example embodiment. At step 702, the AR display device 101 and/or server 110 receives video, position, and pose data from a drone. At step 704, the first set of coordinate space from the position and pose data is converted into a second set of coordinate space of a virtual world model. At step 706, information of an AR object associated with a second set of coordinates is retrieved. At step 708, the AR object is displayed in video based on the second set of coordinates for the AR object.

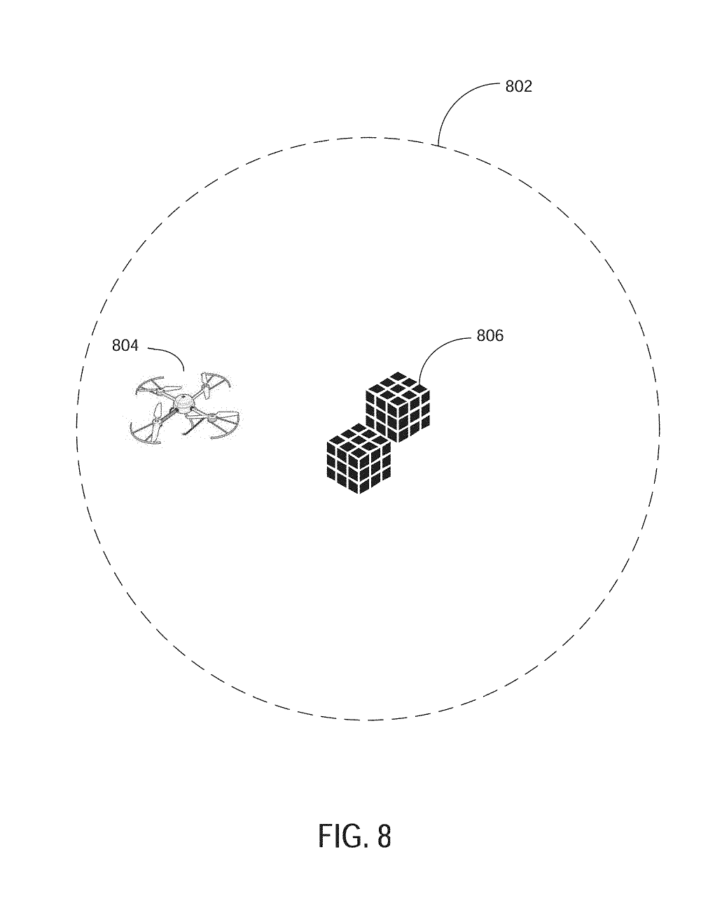

FIG. 8 is a block diagram illustrating an example of a drone 804 located in a physical space 802 associated with a virtual object 806. As discussed above, once the drone 804 enters a particular space, the drone may interact with the virtual object 806. In another aspect, the virtual object 806 may be rendered once the drone enters and/or approaches the physical space 802.

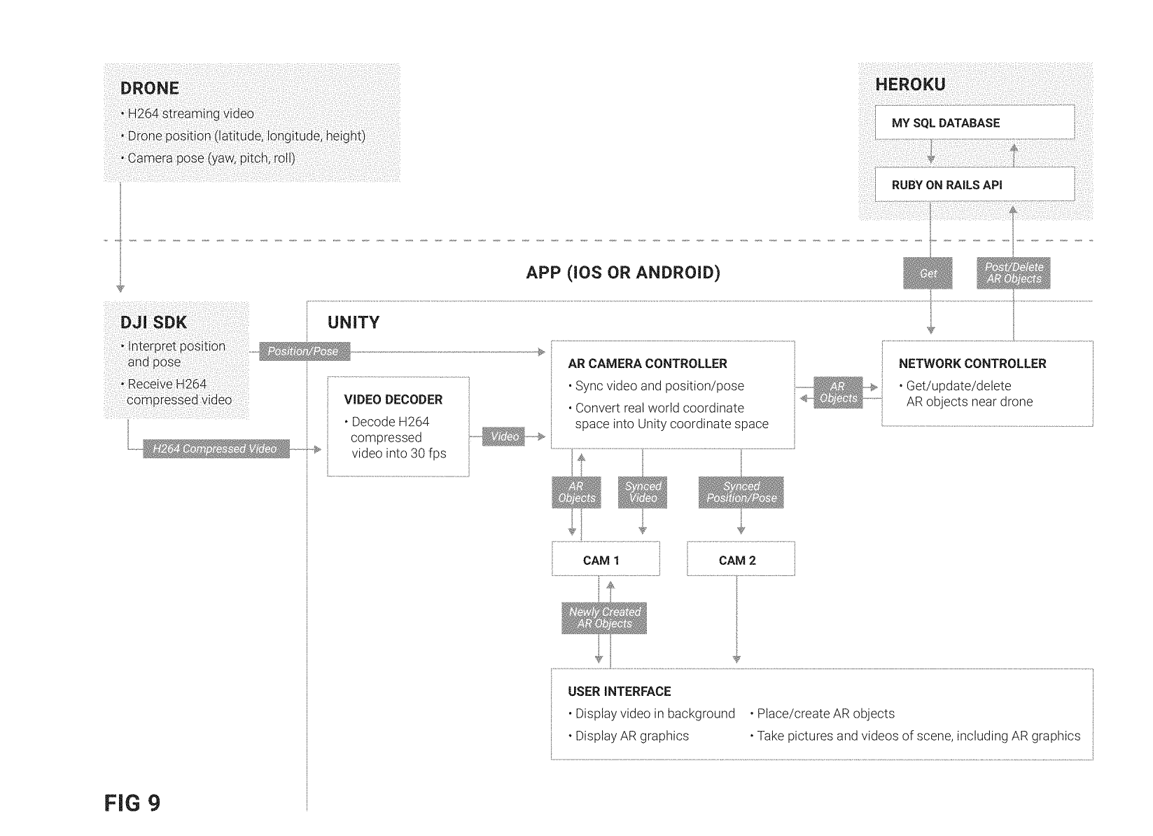

FIG. 9 is a block diagram illustrating an example architecture of a system for authoring and viewing AR content using a drone, according to some example embodiments. As shown in FIG. 9, the system includes a drone, mobile application, and a cloud platform. The drone may utilize H.264 video compression standard to stream the acquired video feed to the mobile application. The drone will also transmit its position (latitude, longitude, and altitude) and the camera pose, namely, yaw, pitch, and roll to the application.

As shown in FIG. 9, the H.264-compressed video, drone position, and camera pose are received by the mobile application. The drone position and camera pose are interpreted and such information is sent to the AR Camera Controller component of the application.

The H.264-compressed video is sent to a Video Decoder component that decodes the video into 30 fps. The decoded video stream is then sent to the AR Camera Controller component of the application.

The AR Camera Controller component synchronizes the video with the drone position and camera pose. The AR Camera Controller also converts real world coordinate space into Virtual World (e.g., Unity) coordinate space. The AR Camera Controller can send synchronized video, drone position, and camera pose information to the User Interface. Additionally, the AR Camera Controller can send and receive AR objects that are created by and/or requested by the operator.

The mobile application also has a User Interface (UI) component that displays video feed in the background and overlays any AR graphics or AR objects. The UI also has an interface to allow a user to create, place, or delete AR objects. Other UI functions include taking pictures and videos of a particular scene, which include the AR graphics and objects. The UI may include different menus and toolbars to adjust drone functions (e.g., auto takeoff); turn on/off “return home” features; camera setting such as, but not limited to, camera settings; and adjust AR settings. The AR settings may include options and features to create, manipulate the AR graphics and objects; turning the AR display on and off (i.e., providing the user with the ability to change the display to add or remove AR objects from being presented on the display); and adjusting background contrast.

The system also includes a platform may be a Heroku platform or any other platform known or developed in the art. In one embodiment the platform includes a My SQL Database and uses Ruby on Rails API or any other API known or developed in the art. The platform may send AR objects, updates, or other information to the Network Controller component of the application. The Network Controller component also sends information to the platform about AR objects posted or deleted through the mobile application.

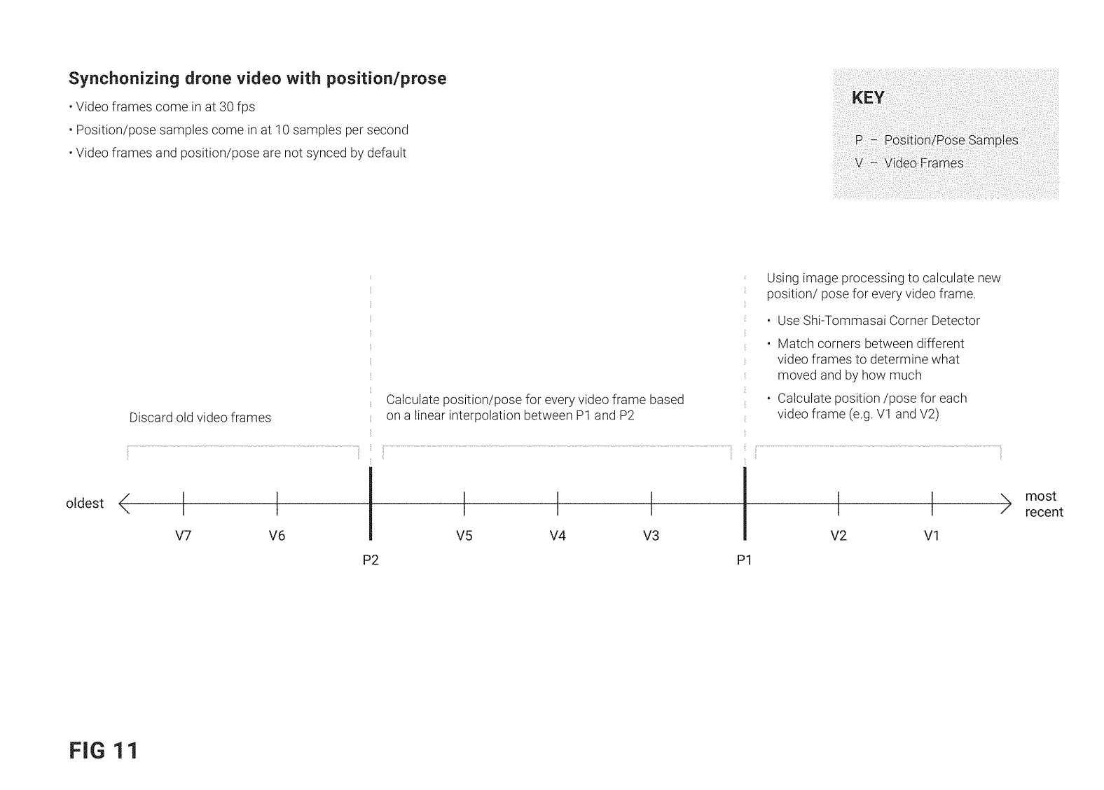

FIG. 11 illustrates a method for synchronizing video frames with a position/pose data, according to some example embodiments. By default, the drone position and camera pose are not synchronized with the video frames. That is, video frames come in at 30 fps whereas position and pose information comes in at 10 samples per second. FIG. 11 illustrates a sequence of video frames (V) and drone position/camera pose samples (P). According to one method, the oldest video frames are discarded. Using the example shown in FIGS. 11, V6 and V7 (i.e., video frame 6 and video frame 7) are discarded. The drone position and camera pose for every video frame calculated based on a linear interpolation between adjacent pose examples. As shown in FIG. 11, position/pose information from P1 and P2 is used to calculate the drone position and camera pose for every video frame. Image processing is then used to calculate a new position/pose for every video frame. The Shi-Tommsi Corner Detector is then applied to every video frame. The corners between different frames are compared to determine what position and/or pose element has changed between the various frames. The position/pose for each frame is then calculated.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 212 or a group of processors 212) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor 212 or other programmable processor 212) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 212 configured using software, the general-purpose processor 212 may be configured as respective different hardware modules at different times. Software may accordingly configure a processor 212, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 212 that are temporarily configured (e.g., by software) or permanently configured to perform the relevant operations. Whether temporarily or permanently configured, such processors 212 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 212 or processor-implemented modules. The performance of certain of the operations may be distributed among the one or more processors 212, not only residing within a single machine, but deployed across a number of machines. In some example embodiments, the processor or processors 212 may be located in a single location (e.g., within a home environment, an office environment, or a server farm), while in other embodiments the processors 212 may be distributed across a number of locations.

The one or more processors 212 may also operate to support performance of the relevant operations in a “cloud computing” environment or as a “software as a service” (SaaS). For example, at least some of the operations may be performed by a group of computers (as examples of machines including processors 212), these operations being accessible via a network 108 and via one or more appropriate interfaces (e.g., application programming interfaces (APIs)).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 212, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 212 executing a computer program to perform functions by operating on input data and generating output. Method operations can also be performed by, and apparatus of example embodiments may be implemented as, special-purpose logic circuitry (e.g., an FPGA or an ASIC).

A computing system can include clients and servers 110. A client and server 110 are generally remote from each other and typically interact through a communication network 108. The relationship of client and server 110 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 212), or in a combination of permanently and temporarily configured hardware may be a design choice. Below are set out hardware (e.g., machine) and software architectures that may be deployed, in various example embodiments.

### Example Machine Architecture

FIG. 10 is a block diagram of a machine in the example form of a computer system 1000 within which instructions 1024 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 110 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, a network switch, a network bridge, or any machine capable of executing instructions 1024 (sequential or otherwise) that specify actions to be taken by that machine. Further, while only a single machine is illustrated, the term “machine” shall also be taken to include any collection of machines that individually or jointly execute a set (or multiple sets) of instructions 1024 to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a disk drive unit 1016, a signal generation device 1018 (e.g., a speaker), and a network interface device 1020.

### Machine-Readable Medium

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media 1022. The instructions 1024 may also reside, completely or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers 110) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present embodiments, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1024 may further be transmitted or received over a communication network 1026 using a transmission medium. The instructions 1024 may be transmitted using the network interface device 1020 and any one of a number of well-known transfer protocols (e.g., hypertext transfer protocol (HTTP)). Examples of communication networks 1026 include a local-area network (LAN), a wide-area network (WAN), the Internet, mobile telephone networks, plain old telephone service (POTS) networks, and wireless data networks (e.g., Wi-Fi and WiMax networks). The term “transmission medium” shall be taken to include any intangible medium capable of storing, encoding, or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving video data, location data, position data from a remotely controlled unmanned aerial vehicle (UAV);
converting a first set of coordinates from the location and position data to a second set of coordinates of a virtual world model;
receiving a selection of an AR object at an AR display device used to control the remotely controlled UAV;
associating the selected AR object with the second set of coordinates; and
providing information of the selected AR object and the second set of coordinates to a server.

2. A method comprising:
receiving video data, location data, position data from a remotely controlled unmanned aerial vehicle (UAV);
converting a first set of coordinates from the location and position data to a second set of coordinates of a virtual world model;
retrieving information of an AR object associated with the second set of coordinates; and
displaying the AR object in a video feed from the UAV.

3. A non-transitory computer-readable medium comprising instructions that, when executed by one or more processors of a machine, cause the machine to perform operations comprising:
receiving video data, location data, position data from a remotely controlled unmanned aerial vehicle (UAV);
converting a first set of coordinates from the location and position data to a second set of coordinates of a virtual world model;
receiving a selection of an AR object at an AR display device used to control the remotely controlled UAV;
associating the selected AR object with the second set of coordinates; and
providing information of the selected AR object and the second set of coordinates to a server.

4. A non-transitory computer-readable medium comprising instructions that, when executed by one or more processors of a machine, cause the machine to perform operations comprising:
receiving video data, location data, position data from a remotely controlled unmanned aerial vehicle (UAV);
converting a first set of coordinates from the location and position data to a second set of coordinates of a virtual world model;
retrieving information of an AR object associated with the second set of coordinates; and
displaying the AR object in a video feed from the UAV.
